(19) United States
(12) Patent Application Publication
(10) Pub. No.: US 2008/0000432 A1
(43) Pub. Date: Jan. 3, 2008

(54) Glove with mounted retractable pet leash

(76) Inventor: Omar Alhegelan, Eloy, AZ (US)

Correspondence Address: JOHN S. HALE;GIPPLE & HALE, 6665-A OLD DOMINION DRIVE, MCLEAN, VA, 22101, US

(21) Appl. No.: 11/478,768

(22) Filed: Jul. 3, 2006

(51) Int. Cl. A01K 27/00

(52) U.S. Cl. 119/796

(57) ABSTRACT

A retractable pet leash comprising a glove with a reel housing assembly mounted on a rear section of the glove. The reel housing assembly comprises a leash housing secured to a base plate, a spring means mounted in housing for winding said cord means onto the reel with the base plate being secured to the glove. A spring biased reel is rotatably mounted in reel housing and the cord means are retractably wound on reel. The cord means has a free end for attachment to a pet.

### RELATED APPLICATIONS

There are no related applications.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### FIELD OF THE INVENTION

The present invention generally relates retractable pet leash and more particularly to a wearable assembly having a retractable pet leash mounted thereon.

### BACKGROUND OF THE INVENTION

Retractable leashes for pets are well known in the art. These leashes provide for variable connection between a pet and the owner. These leashes in many instances have a spring-biased spooling assembly for automatically taking up the slack in a leash.

The wind-up spool is disposed in a housing with a thumb-actuated brake for controlling the amount of leash to be dispensed. A drawback to known retractable dog leashes is the retractor must be held in a grip held with one hand. This can make running or carrying items such as groceries difficult with your pet in tow. Another problem with existing retractor leashes is when the user needs to get the pet away from another animal as, for example, when a dog gets into a fight with another dog, only one hand is free to separate two animals

The present invention relates to a retractable leash for animals which includes a glove provided with a housing in which the length of a leash exiting the housing can be taken up, and which can be stopped by means of a brake mechanism.

Compared to conventional leashes, retractable leashes have the advantage that they automatically wind up excess leash length on a spring-biased reel. For the user walking the animal, retractable leashes of this kind are generally equipped with a fixed-size grip that is integral with the housing. One advantage of a design of this kind is that it permits a very simple production process. A disadvantage, however, is that different users have different-sized hands that do not all fit into a single-sized grip. Optimal operation and handling of such a leash can accordingly not be guaranteed and one hand is engaged with the grip.

If, for example, a person with a small hand uses such a retractable leash for a large animal, the grip will be too large, since the pulling force on the leash and the direction of pull will cause the user's hand to slip automatically to the lower end of the grip. If this happens, the user's thumb can no longer reach the actuating buttons at the top end of the grip. In dangerous situations it is thus almost impossible to keep an animal under control.

The opposite situation occurs, for example, when a person with a large hand uses a retractable leash for a small animal. In this case, the grip is too small. The thumb of the hand holding the leash can admittedly always reach the actuating buttons at the top of the grip, but since only two or three fingers fit into the grip, walking an animal on the leash becomes very uncomfortable with time.

U.S. Pat. No. 6,688,260 issued Feb. 10, 2004 discloses a pet leash that can alternately be held in a users hand or secured to a belt worn by the user. The leash is retractable inside a housing having a concave surface designed to conform generally to the shape of a user's hip or waist.

U.S. Pat. No. 6,886,499 issued May 3, 2005 discloses a spring activated leash housing having a hand grip secured to one end. Another handle grip with an integral spring biased reel is shown by U.S. Pat. No. 6,904,872. This reel provides for the slack section of the leash to be taken up automatically by the reel when the maximum extension length is not being used.

U.S. Pat. No. 4,753,442 issued Jun. 28, 1968 is directed toward a baseball glove with an automatic ball return device which is removably mounted on the back of the baseball glove by Velcro® sections with the cord from the housing running from the side of the housing through the webbing and the end of the cord is secured to a baseball.

U.S. Pat. No. 5,435,273 issued Jul. 25, 1995 discloses an attachment leash element integral with a glove and a leash which is mountable in the leash element.

U.S. Pat. No. 6,368,241 issued Apr. 9, 2002 discloses a wrist band fastener secured around a wrist of the user by hook and pile fastening means to which an elastic cord is attached with the distal end of the cord being secured to a baseball.

### SUMMARY OF THE INVENTION

The present invention is an improvement to animal leashes that are used to walk and control animals attached thereto such as dogs or the like. The improvement is directed to combining a leash with a hand encompassing glove or wrist band so as to allow the user's full gripping potential to be utilized while leaving the user's hand free for other tasks. The leash is spring mounted on a spool mounted in a housing which is mounted in the glove with the leash extending from the glove over the back of the users hand.

It is an object of the invention to provide a glove with a retractable leash mechanism secured thereto.

It is another object of the invention to provide a leash housing that is circular so that the same presents no sharp surfaces when the leash is being used.

It is still another object of the invention to provide a means for locking and releasing the leash on the reel housing.

It is yet another object of the invention to provide a self-contained animal leash to securely hold a large dog or other animal on a leash comprising a glove which is worn by the user having an attachment leash element integral with the glove leaving the hand on which the leash is mounted free for other uses.

A retractable pet leash is disclosed that can alternatively be mounted in a glove worn on the users hand or on a wrist band worn on a users wrist. The retractor retracts a first length of leash that has a first connector coupled to its distal end.

The above and other objects, feature and advantages of the present invention will be apparent in the following detailed description thereof when read in conjunction with the appended drawings wherein the same reference numerals denote the same or similar parts throughout the several views.

### BRIEF DESCRIPTION OF THE DRAWINGS

The invention will be better understood and objects other than those set forth above will become apparent when consideration is given to the following detailed description thereof. Such description makes reference to the annexed drawings wherein.

FIG. 1 is perspective view of the glove with mounted retractable leash apparatus attached to the collar of an animal;

FIG. 2 is an enlarged top plan view of the retractable leash apparatus shown in FIG. 1;

FIG. 3 is an enlarged side elevational view of the retractable leash apparatus shown in FIG. 2; and

FIG. 4 is a top plan view of another embodiment of the retractable leash apparatus.

### DETAILED DESCRIPTION OF THE INVENTION

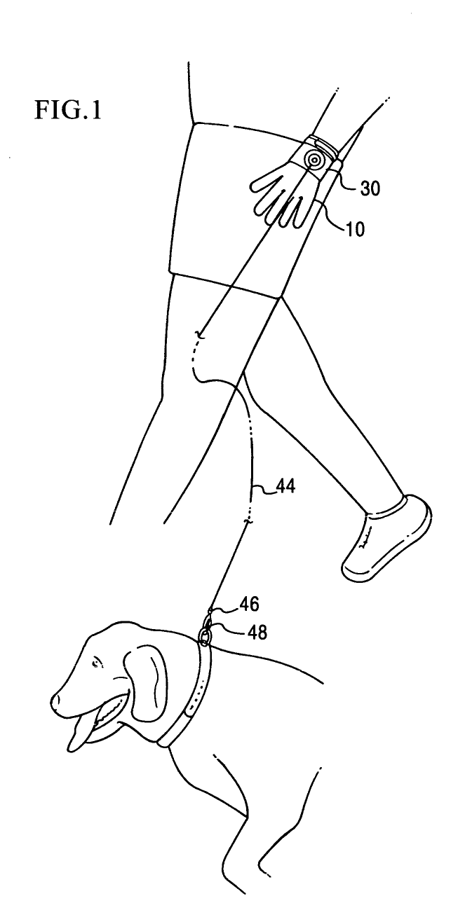

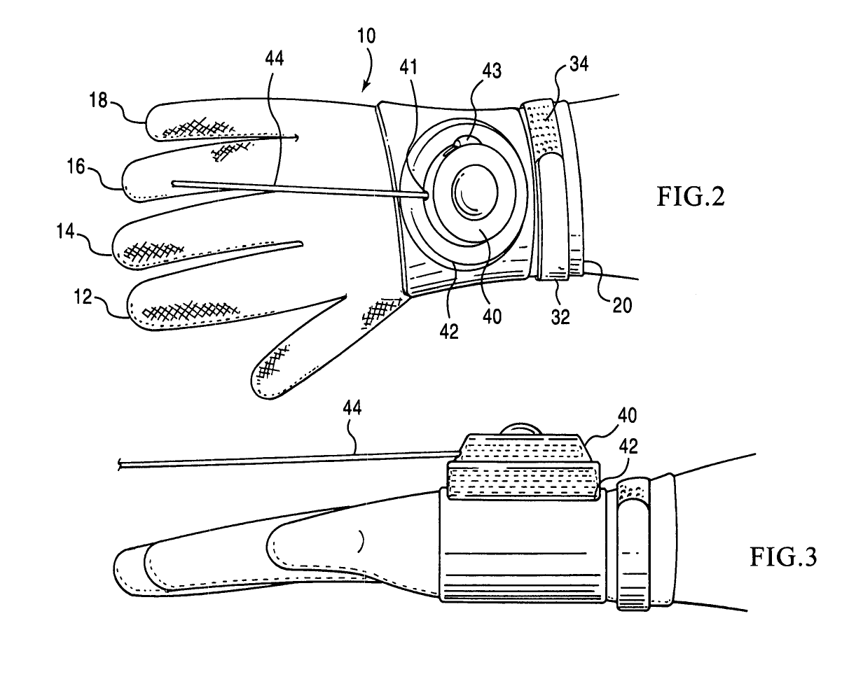

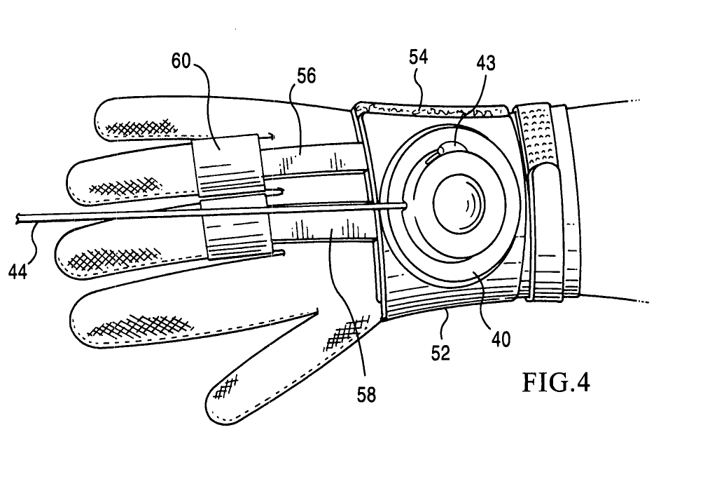

The preferred embodiment and best mode of the invention is shown in FIGS. 1 through 3. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

Referring to the drawings in detail, and initially to FIGS. 1-3 thereof, there is shown a glove 10 including a plurality of finger portions 12, 14, 16, and 18, accessible through an end opening 20 and through which the user inserts his fingers for holding the retractable leash glove 10 on his or her hand. The leash assembly 30 includes a circular leash housing 40 fixedly secured to a support plate 42 which can be mounted in pockets formed on the glove 10 or inserted into a cavity formed in the glove 20. Housing 40 can be any suitable housing made of, for example, plastic, leather or metal. In this regard, housing 40 should preferably be mounted and positioned on the back of the glove 10. A strap 32 is mounted at the back of the glove which has a hook and pile fastening section 34 allowing the strap 32 to be tightly secured around the user's wrist so that the glove 10 cannot be pulled off of the user's hand by the pulling action of the pet.

A spool or reel (not shown) is spring mounted within housing 40 as is well known in the art and has a cord or leash 44 wound thereabout, with one end of leash cord being secured to the reel and the opposite, free end of cord 46 having a clip 48 which is attached to the pet collar in the usual manner. While the invention is envisioned primarily as a dog leash, it can be used for other animals such as a Vietnamese pot belly pig, skunk, cat or other animals. Cord 46 extends from the spring biased reel through an opening 41 in the housing 40. The cord is preferably of thin diameter so that it can be wound on the spool but of a sufficient strength to withstand the tensile force exerted by an animal pulling the leash.

The wind-up reel retractor, is disposed inside the housing 40 and is rotatable about the axis of rotation. The reel retractor includes a spring that is biased to retract the cord of leash towards into the housing so that when the reel is fully retracted, the clip 48 is adjacent the opening 41. The opening 41 in the housing 40 is sized to allow the leash portion 44 to slide in and out but not allow the clip connector 48 to be pulled through. A manually actuated brake or lock 43 in the form of an easy button is mounted in the housing 40 may be actuated by a user with a single push to lock the cord of the leash in place with a second push unlocking the cord allowing it to be withdrawn or retracted depending on the tension applied to the cord. The leash cord may be made from a flexible material such as nylon and may also have a reflector or luminescent material coated thereon to be more visible in a darkened environment.

An alternative wrist embodiment 50 is shown mounted on glove 10. It will be apparent that this could also be mounted directly to a user's hand and fingers. A band 52 having hook and pile fastening sections 54 such as Velcro® is wrapped around the users wrist with the fastening sections 54 engaging each other to hold the wrist band firmly in place. A leash housing 40 constructed identical to that shown in FIGS. 1-3 is secured to the band 52 by adhesive, rivets or a plate which is placed in pocket of the band. Extending outward from the band 52 are a plurality of finger supports 56. Each finger support 56 is constructed with a linear extension member 58 and a finger encircling member 60 secured to the distal end of the extension member. The proximal end of the linear extension member is secured to band 52 by stitching, rivets or adhesive. The finger encircling member 60 can be a unitary circular member or a strip transverse to the axis of the extension member. The ends of the strip have hook and pile fastening portions allowing the same to be secured to each other.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What I claim is:

1. A retractable pet leash comprising:
a glove, a reel housing assembly mounted on a rear section of said glove, said reel housing assembly comprising a leash housing secured to a base plate, said base plate being secured to said glove,
a spring biased reel rotatably mounted in said reel housing;
cord means retractably wound on said reel and having a free end for attachment to a pet;
and spring means mounted in said housing for winding said cord means onto said reel;
control means on said housing for locking said cord to prevent said cord from additional dispensing after a predetermined amount of cord has been dispensed.

2. A retractable pet leash as claimed in claim 1; wherein said housing is removably securable to a rear portion of said glove.

3. A retractable pet leash as claimed in claim 1 wherein said reel housing is circular in shape.

4. A retractable pet leash as claimed in claim 1 wherein said base plate is secured to pockets formed in said glove.

5. A retractable pet leash as claimed in claim 1 wherein said control means is a lock button which locks the cord at a desired length.

6. A retractable pet leash as claimed in claim 1 wherein said base plate is secured to said glove by adhesive.

7. A retractable pet leash as claimed in claim 1 wherein said base plate is plastic.

8. A retractable pet leash as claimed in claim 1 wherein said base plate is metal.

9. A retractable pet leash as claimed in claim 1 wherein said base plate is leather.

10. A retractable pet leash as claimed in claim 1 wherein said glove has a tightening strap mounted on the rear of the glove.

11. A retractable pet leash as claimed in claim 10 wherein said tightening strap has hook and pile fastening sections.

12. A retractable pet leash, comprising: a wind-up spool having an axis of rotation, said spool holding a length of flexible leash; a housing holding said spool, a spring for biasing the spool to retract the length of flexible leash into the housing; and a manually actuated brake disposed on the housing to prevent the leash from moving relative to the housing, said housing being mounted on the back of a glove on a base plate secured to said glove, said flexible leash having a clip mounted at its distal end.

13. A retractable pet leash as claimed in claim 12 wherein said base plate has ends mounted in pockets formed in said glove.

14. A retractable pet leash as claimed in claim 12 wherein said base plate is metal.

15. A retractable pet leash as claimed in claim 12 wherein said glove has a tightening strap mounted on the rear of the glove.

16. A retractable pet leash comprising a wrist band:
a reel housing assembly mounted on a rear section of said wrist band, said reel housing assembly comprising a leash housing secured to a base plate, said base plate being secured to said wrist band,
a spring biased reel rotatably mounted in said reel housing;
cord means retractably wound on said reel and having a free end for attachment to a pet;
spring means mounted in said housing for winding said cord means onto said reel;
control means for locking said cord after a predetermined amount of cord has been dispensed; and
a plurality of support finger members secured to said wrist band, each finger member comprising a linear extension member secured to said wrist band and a finger encircling member secured to the distal end of said extension member.

17. A retractable pet leash as claimed in claim 16 wherein said wrist band has hook and pile sections secured thereto which engage each other to fasten the wrist band around the user's wrist.

18. A retractable pet leash as claimed in claim 16 wherein said finger encircling member has hook and pile sections secured thereto which engage each other to fasten the encircling member around the user's finger.

19. A retractable pet leash as claimed in claim 16 wherein said finger encircling members are a unitary piece of material.

20. A retractable pet leash as claimed in claim 16 wherein said finger encircling members are at least one strip of material positioned transverse the axis of the extension member.

21. A retractable pet leash as claimed in claim 16 wherein said reel housing is circular in shape.
